(19) United States
(12) Patent Application Publication
(10) Pub. No.: US 2014/0158841 A1
(43) Pub. Date: Jun. 12, 2014

(54) SUPPORT STRUCTURE FOR DISPLAYING A HELMET

(71) Applicant: Robert Patrick MOONEY, Chester, MD (US)

(72) Inventor: Robert Patrick MOONEY, Chester, MD (US)

(21) Appl. No.: 13/804,938

(22) Filed: Mar. 14, 2013

Related U.S. Application Data
(60) Provisional application No. 61/735,316, filed on Dec. 10, 2012.

(51) Int. Cl. F21V 21/00

(52) U.S. Cl. CPC F21V 21/00
USPC 248/158

(57) ABSTRACT

A helmet display device for supporting and displaying a helmet on a light fixture is provided. The device has a helmet supporting area configured to contact an inside surface of the helmet and hold the helmet in a fixed position around a light bulb of the light fixture; and a ventilation opening adjacent the helmet supporting area configured to dissipate heat generated by the light bulb.

### BACKGROUND OF THE INVENTION

1. Field of the Disclosed Embodiments

The disclosed embodiments relate to a structure that supports and displays a helmet such as, for example, a sports helmet.

2. Introduction

Many people have helmets of one type or another, for example sports helmets, that represent memories or other significant things in their lives. These helmets are often displayed as a reminder of significant events or interests. But often such helmets are simply stored away due to a lack of an acceptable display method. As a result, there is a need for a simple and attractive way to display these important helmets.

Many people also have table lamps, or other lamps, that have shades that are outdated or otherwise do not satisfy current decoration needs.

The invention provides a simple, inexpensive and attractive way to display a helmet using a basic table lamp or other light fixture.

### SUMMARY

Particular embodiments of the invention are directed to a helmet display device for supporting and displaying a helmet on a light fixture. The device includes a helmet supporting area configured to contact an inside surface of the helmet and hold the helmet in a fixed position around a light bulb of the light fixture; and a ventilation opening adjacent the helmet supporting area configured to dissipate heat generated by the light bulb.

Particular embodiments of the invention are directed to a helmet display device for supporting and displaying a helmet on a light fixture. The device includes a helmet supporting area configured to contact an inside surface of the helmet and hold the helmet in a fixed position around a light bulb of the light fixture; a ventilation opening adjacent the helmet supporting area configured to dissipate heat generated by the light bulb; and the light fixture. The light fixture includes a base for supporting the device on a support surface; and a support post attached to the base at a first end and the helmet supporting area at a second end opposite the first end such that the helmet supporting area is positioned above the base.

An appropriate light fixture with the shade, and if necessary any shade support structure, removed and an appropriate light bulb is all that is needed in addition to the invention to provide a simple and attractive helmet display device.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a side view of a first embodiment of the invention;

FIG. 2 is a side view of a particular embodiment of the invention;

FIG. 3 is a side view of a particular embodiment of the invention;

FIG. 4 is a side view of particular embodiments of the invention with a helmet in place;

FIG. 5 shows a particular embodiment of the invention;

FIG. 6 shows the embodiment shown in FIG. 5 with a helmet in place;

FIG. 7 is a side view of a particular light bulb for use with embodiments of the invention;

FIG. 8 is a side view of particular embodiments of the invention using the light bulb of FIG. 7 with a helmet in place;

FIG. 9 shows a particular embodiment of the invention;

FIG. 10 shows the embodiment shown in FIG. 9 with a helmet in place;

FIG. 11 shows another embodiment of the invention; and

FIG. 12 shows another embodiment of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

Various embodiments of the disclosed embodiments may be discussed in detail below. While specific implementations may be discussed, it should be understood that this be may be done for illustration purposes only. A person skilled in the relevant art may recognize that other components and configurations may be used without parting from the spirit and scope of the disclosed embodiments.

The disclosed embodiments comprise a variety of embodiments, such as a method and apparatus and other embodiments that relate to the basic concepts of the disclosed embodiments.

As explained above, there is a need for a simple, inexpensive and attractive way to display sports, or other, helmets. Described herein are two examples of embodiments of the invention.

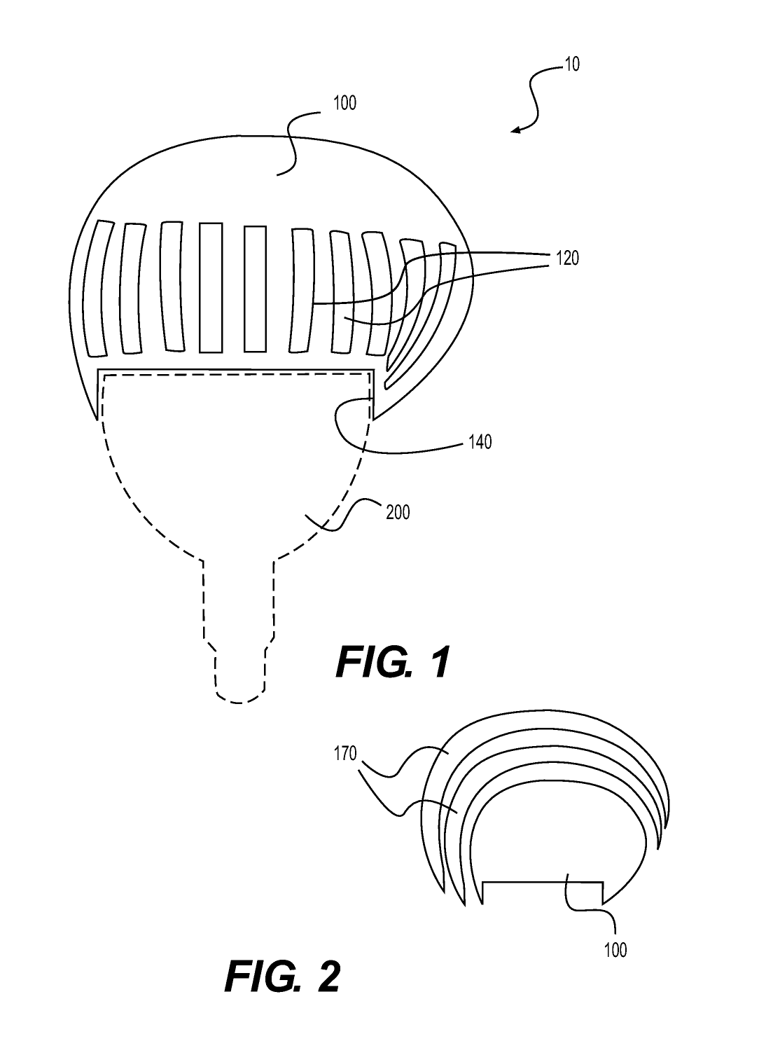

FIG. 1 shows an example of a device 10 that can be attached to a light bulb 200 to securely support a helmet for displaying. Device 10 has a helmet supporting area 100 that can include one or more ventilation openings 120 and a bulb holding area 140. Bulb holding area 140 is sized and configured in order to securely grip the top, and/or other areas, of a particular commonly available light bulb. Particular embodiments of the invention include adapter pieces that attached to bulb holding area 140 and are sized and shaped to securely grip other commonly available light bulbs.

Many common desk lamps have a wire or other frame that extends around the light bulb and supports the lamp shade. With this type of lamp, the shade and the shade support structure are removed such that no part of the lamp exists above the light bulb. In some cases, a new light bulb may be needed so that device 10 is properly supported by the light bulb. In addition, the operating temperature of the light bulb must be considered so that no part of device 10 is subjected to temperatures above those that can be tolerated by device 10. Light bulbs that have either low surface temperatures and/or have protective structures are particularly well suited for use with device 10.

FIG. 2 shows a particular embodiment of the invention that includes one or more shells 170 that attach to helmet supporting area 100 and are sized and shaped to conform to the inside of particular sized helmets. A great number of memorabilia helmets are one of a few standard sizes. A set of just a few shells 170 can provide secure mounting of most memorabilia helmets, and also a great number of actual sports helmets.

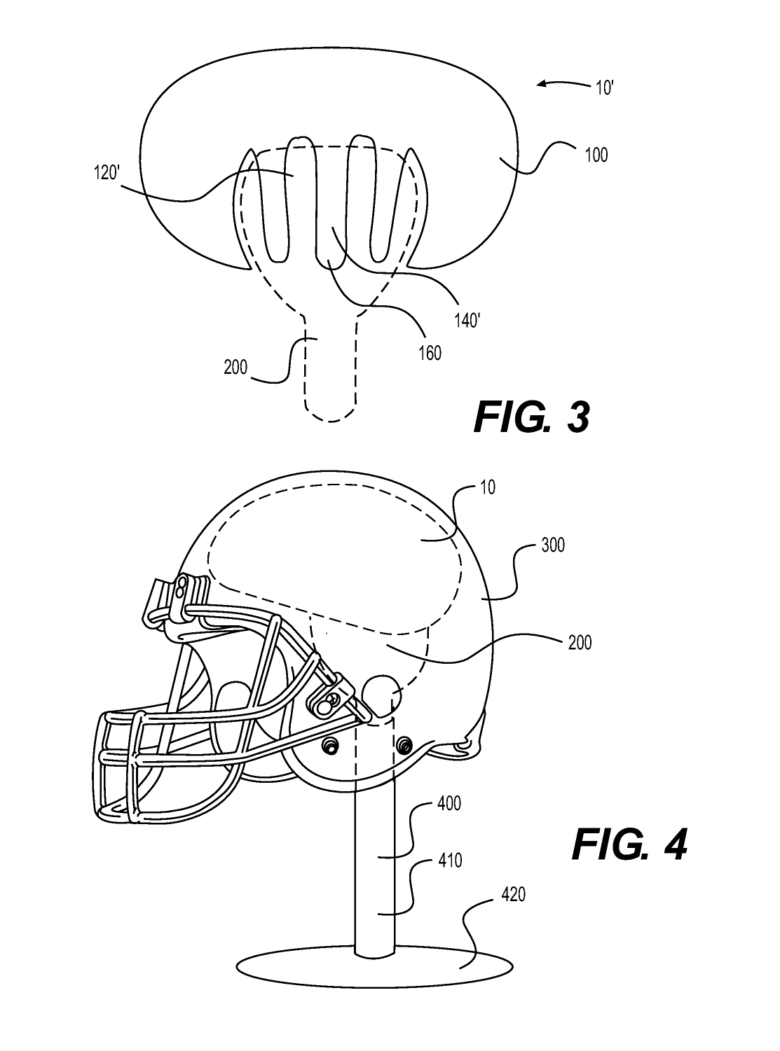

FIG. 3 shows another example of a device 10′ that has open ended ventilation openings 120′ instead of the slot-like ventilation openings 120 shown in FIG. 1. Ventilation openings 120′ are the result of a bulb holding area 140′ that includes a number of fingers 160 that grip light bulb 200. The adapter pieces described above and shells 170 shown in FIG. 2 can also be used with the embodiment of the invention shown in FIG. 3.

FIG. 4 shows an example of a helmet 300 in place on device 10 attached to a light fixture 400. Light fixture 400, in this example, has a post 410 and a base 420. As shown in FIG. 4, device 10 conforms to the inside shape of helmet 300 and transfers the weight of helmet 300 to light fixture 400 through light bulb 200. It is noted that even though football helmets are shown and described, other types of helmets such as, for example, lacrosse helmets, hockey helmets, baseball batting helmets, softball helmets, fireman helmets, motorcycle helmets, aircraft helmets and military helmets can also be used with the invention. This list is exemplary only and is not limiting.

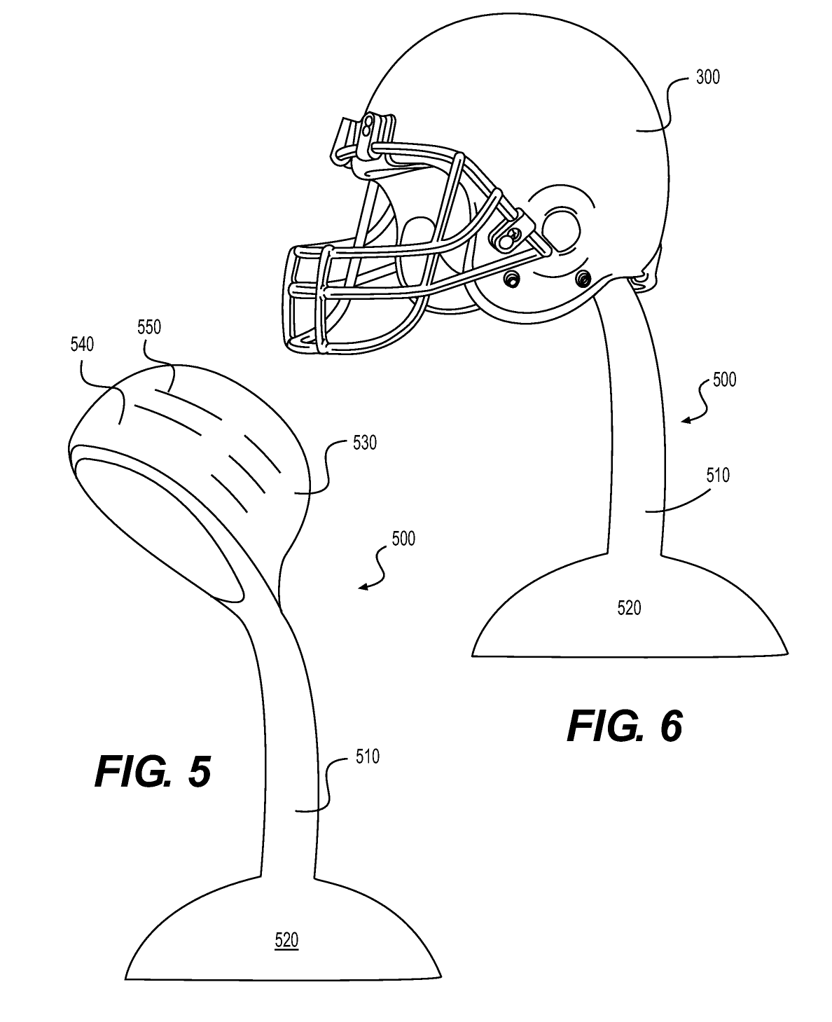

FIGS. 5 and 6 show an embodiment of the invention in which a helmet supporting area 530 is attached to, and in some cases integrally formed with, a post 510 of a lamp or other light fixture 500. In this example, lamp 500 has a base 520 and helmet supporting area 530 has a solid area 540 and one or more ventilation openings 550. This embodiment of the invention can be provided as a complete unit, whereas the embodiments shown in FIGS. 1-4 can be provided for use with a separately provided light fixture. This embodiment can be a floor lamp, a table lamp, or many other types of lamps.

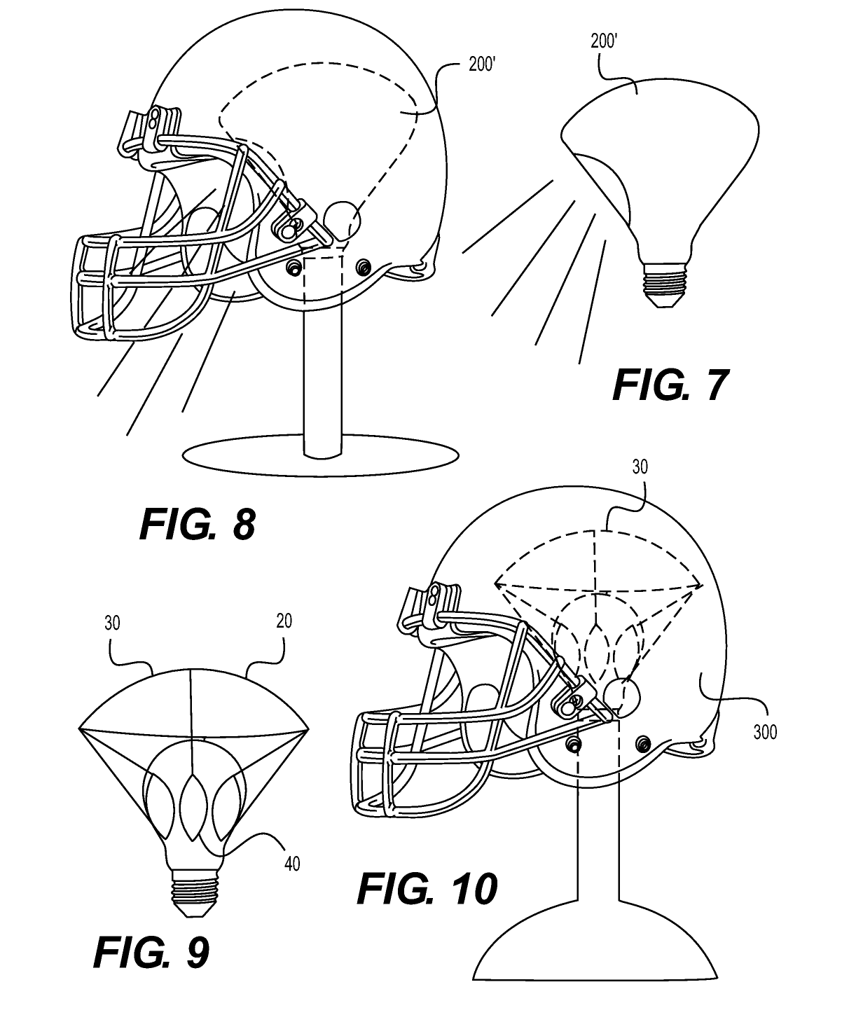

FIG. 7 shows a light bulb 200′ that is suitable for use with embodiments of the invention. Light bulb 200′ emits light only, or at least predominantly, in one general direction. As shown in FIG. 8, this type of light bulb is particularly well suited with embodiments of the invention because the light is directed out of the face area of the helmet. This not only produces more direct light, but it also can reduce the amount of heat to which the helmet is subjected.

FIGS. 9 and 10 show an example of an embodiment of the invention that uses a wire, or other material, frame 20 to support a helmet on a light bulb. Frame 20 has a helmet supporting area 30 and a bulb holding area 40.

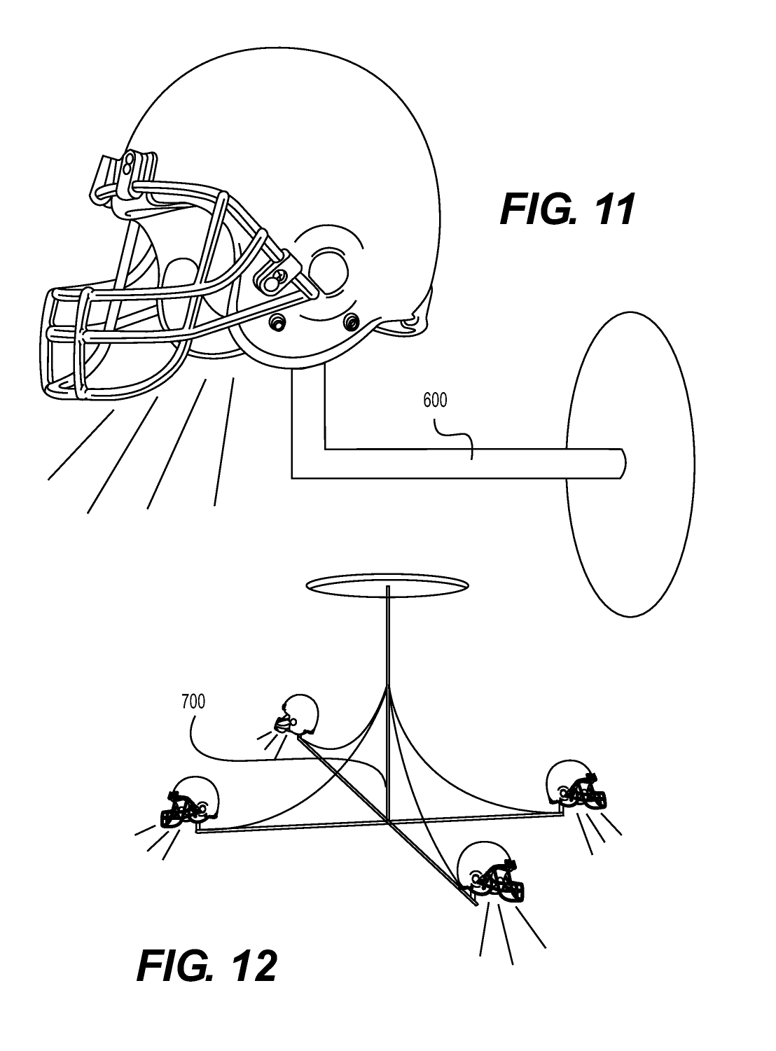

FIG. 11 shows an example of the invention that is embodied in a wall sconce 600 and FIG. 12 shows an example of the invention that is embodied in a chandelier 700. The various structures described above can be implemented in these embodiments.

Although the above description may contain specific details, they should not be construed as limiting the claims in any way. Other configurations of the described embodiments of the disclosed embodiments may be part of the scope of the disclosed embodiments. For example, the principles of the disclosed embodiments may be applied to each individual user where each user may individually deploy such a system. This be enables each user to utilize the benefits of the disclosed embodiments even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosed embodiments, rather than any specific examples given.

What is claimed is:

1. A helmet display device for supporting and displaying a helmet on a light fixture, the device comprising:
a helmet supporting area configured to contact an inside surface of the helmet and hold the helmet in a fixed position around a light bulb of the light fixture; and
a ventilation opening adjacent the helmet supporting area configured to dissipate heat generated by the light bulb.

2. The device of claim 1, further comprising a light bulb receiving area configured to contact the light bulb and transfer the weight of the helmet onto the light bulb.

3. The device of claim 2, wherein the light bulb receiving area is configured to contact a shroud portion of the light bulb.

4. The device of claim 3, wherein the helmet supporting area is non-spherically shaped such that the helmet supporting area is configured to restrict the location of a face opening in the helmet to a particular portion of the helmet supporting area, the face opening in the helmet being an area of the helmet through which a face of a wearer of the helmet can be seen when the helmet is worn by the wearer, and the particular portion being less than the entire helmet supporting area.

5. The device of claim 4, further comprising a light opening adjacent to a face area of the helmet supporting area, the light opening being configured to allow light generated by the light bulb to exit the face opening in the helmet.

6. The device of claim 3, further comprising a light opening adjacent to a face area of the helmet supporting area, the light opening being configured to allow light generated by the light bulb to exit a face area of the helmet, the face area of the helmet being an area of the helmet through which a face of a wearer of the helmet can be seen when the helmet is worn by the wearer.

7. The device of claim 5, wherein the helmet supporting area is a basic helmet supporting area and the device further comprises an adapter shell that fits on the basic helmet supporting area to form a larger helmet supporting area that is adapted to accommodate a larger helmet than the basic helmet supporting area.

8. The device of claim 2, wherein the helmet supporting area is a basic helmet supporting area and the device further comprises an adapter shell that fits on the basic helmet supporting area to form a larger helmet supporting area that is adapted to accommodate a larger helmet than the basic helmet supporting area.

9. The device of claim 1, wherein the helmet supporting area is a basic helmet supporting area and the device further comprises an adapter shell that fits on the basic helmet supporting area to form a larger helmet supporting area that is adapted to accommodate a larger helmet than the basic helmet supporting area.

10. The device of claim 1, further comprising the light fixture, wherein the light fixture comprises:
a base for supporting the device on a support surface; and
a support post attached to the base at a first end and the helmet supporting area at a second end opposite the first end such that the helmet supporting area is positioned above the base.

11. The device of claim 10, wherein the helmet supporting area is non-spherically shaped such that the helmet supporting area is configured to restrict the location of a face opening in the helmet to a particular portion of the helmet supporting area, the face opening in the helmet being an area of the helmet through which a face of a wearer of the helmet can be seen when the helmet is worn by the wearer, and the particular portion being less than the entire helmet supporting area.

12. The device of claim 11, further comprising a light opening adjacent to a face area of the helmet supporting area, the light opening being configured to allow light generated by the light bulb to exit the face opening in the helmet.

13. The device of claim 10, further comprising a light opening adjacent to a face area of the helmet supporting area, the light opening being configured to allow light generated by the light bulb to exit a face area of the helmet, the face area of the helmet being an area of the helmet through which a face of a wearer of the helmet can be seen when the helmet is worn by the wearer.

14. The device of claim 13, wherein the helmet supporting area is a basic helmet supporting area and the device further comprises an adapter shell that fits on the basic helmet supporting area to form a larger helmet supporting area that is adapted to accommodate a larger helmet than the basic helmet supporting area.

15. The device of claim 12, wherein the helmet supporting area is a basic helmet supporting area and the device further comprises an adapter shell that fits on the basic helmet supporting area to form a larger helmet supporting area that is adapted to accommodate a larger helmet than the basic helmet supporting area.

16. The device of claim 11, wherein the helmet supporting area is a basic helmet supporting area and the device further comprises an adapter shell that fits on the basic helmet supporting area to form a larger helmet supporting area that is adapted to accommodate a larger helmet than the basic helmet supporting area.

17. The device of claim 10, wherein the helmet supporting area is a basic helmet supporting area and the device further comprises an adapter shell that fits on the basic helmet supporting area to form a larger helmet supporting area that is adapted to accommodate a larger helmet than the basic helmet supporting area.

18. The device of claim 2, wherein the helmet supporting area is a frame having multiple first wire-like elements.

19. The device of claim 18, wherein the light bulb receiving area includes a second wire-like element.

20. The device of claim 1, wherein the helmet supporting area is a frame having multiple wire-like elements.
